(19) United States
(12) Patent Application Publication
(10) Pub. No.: US 2011/0314982 A1
(43) Pub. Date: Dec. 29, 2011

(54) SHEET CUTTER AND BELT PROCESSING TOOL

(75) Inventor: Takeshi Kubota, Yamatokohriyama-shi (JP)

(73) Assignee: NITTA CORPORATION, Osaka-shi, Osaka (JP)

(21) Appl. No.: 13/254,541

(22) PCT Filed: Mar. 3, 2010
(86) PCT No.: PCT/JP2010/053462

§ 371 Date: Sep. 2, 2011

(30) Foreign Application Priority Data
Mar. 6, 2009 (JP) 2009-053881

(51) Int. Cl. B26D 1/08; B26D 7/18; B26F 1/40

(52) U.S. Cl. 83/136

(57) ABSTRACT

A sheet cutter applied to a belt processing tool or the like is provided. The belt processing tool includes a mounting table 2 for mounting a belt thereon; a die holding plate 4 being ascendable and descendable with respect to the mounting table, and having a lower surface to which a Thomson die is fixed; a stripper plate 3 being installed ascendably and descendably above the mounting table, and pressing the upper surface of the belt during descent, and having a slit through which the blade of the Thomson die passes; an operation member including a planar cam and a lever for rotating the planar cam, the planar cam being fixed to the mounting table and pivotally supported on a rotary shaft, and moving up and down by rotation, and having a surface for pressing downward the die holding plate; a means for energizing upward the stripper plate; and a locking member for restricting the raised end of the stripper plate.

### TECHNICAL FIELD

The present invention relates to a sheet cutter for cutting a sheet, such as a belt, into a predetermined shape, and to a belt processing tool. In particular, the present invention relates to a belt joint processing tool for forming an endless flat belt by joining together the end portions of a long flat belt.

### BACKGROUND ART

Finger joint, in which the end portions of a belt are cut into a saw-tooth shape and are joined together, is employed to smoothly and strongly join together the end portions of the belt. The finger joint has the advantages of a large contact area between the end portions, and the enhanced strength of the joint. Patent document 1 describes a method of joining together a flat belt by the finger joint. According to this joint method, the end portions to be joined together are respectively processed into the saw-tooth shape, and are engagedly joined together (refer to FIG. 2).

Patent document 2 discloses a motor-driven cutting machine. In the cutting machine, a workpiece mounted on a stationary platen is blanked from above there by raising and lowering a blanking die having a predetermined shape by a motor-driven cut press mechanism.

In other methods for cutting the end portions of the belt into a saw shape, the end portions of the belt are cut along a mold with scissors; or the belt is incised by slightly shifting a Thomson blade, and is finally formed into the saw-tooth shape as a whole; or the saw-tooth shape is formed by the two operations of blanking a large number of parallel slanting lines at a time by a press machine, and then blanking oppositely inclined slanting lines so as to correspond to the previous inclined slanting lines.

It is difficult to form the shape of the saw-tooth shape by cutting the belt with the scissors into mountains one by one, as in the case of the conventional technique. It is time consuming to form into the saw-tooth shape by blanking with the Thomson blade into mountains one by one. The finishing accuracy thereof is unstable. There is also a device for forming into the saw-tooth shape by the two steps of firstly blanking a slanting surface on one side of a plurality of mountains; and then blanking the rest slanting surface. However, the finishing accuracy thereof is unstable.

On the other hand, the formation into the saw-tooth shape by a single blanking increases the forming accuracy, whereas increases the force required for cutting because of a long cutting line. For example, as in the case of the machine of the patent document 2, a relatively large machine using the motor and oil pressure becomes a necessity. Even in that case, there occurs the disadvantage that the mountain-shaped front end portions of the belt bite into the blade, failing to depart from the blade. It is a complicated work to release the front end portions every time. It is also dangerous to work with the force applied by fingers at a location close to the blade.
Patent document 1: Japanese Unexamined Patent Publication No. 2003-205554
Patent document 2: Japanese Unexamined Patent Publication No. 2001-162590

### SUMMARY OF THE INVENTION

### Problems to be Solved by the Invention

A major object of the present invention is to provide a sheet cutter capable of accurately cutting a sheet into a predetermined shape by a simple manual operation, and safely releasing the sheet from a blade. A further object of the present invention is to provide a belt processing tool for cutting the end portions of the belt into a predetermined shape.

### Means for Solving the Problems

The sheet cutter of the present invention includes a mounting table for mounting a sheet thereon; a die holding plate being ascendable and descendable with respect to the mounting table, and having a lower surface to which a Thomson die is fixed; a stripper plate being installed ascendably and descendably above the mounting table, and pressing the upper surface of the sheet during descent, and slidingly contacting with the blade of the Thomson die; an operation member including a planar cam and a lever for rotating the planar cam, the planar cam being fixed to the mounting table and pivotally supported on a rotary shaft, and moving up and down by rotation, and having a surface for pressing downward the die holding plate; a means for pulling upward the die holding plate as the pressing surface of the planar cam is raised; a means for energizing upward the stripper plate; and a locking member for restricting the raised end of the stripper plate. This permits cutting with the Thomson die.

The belt processing tool of the present invention includes a mounting table for mounting the end portions of a flat belt thereon; a die holding plate being ascendable and descendable with respect to the mounting table, and having a lower surface to which a Thomson die is fixed; a stripper plate being installed ascendably and descendably above the mounting table, and pressing the upper surface of the belt during descent, and having a slit through which a blade of the Thomson die passes; an operation member including a planar cam and a lever for rotating the planar cam, the planar cam being fixed to the mounting table and pivotally supported on a rotary shaft, and moving up and down by rotation, and having a surface for pressing downward the die holding plate; a means for pulling upward the die holding plate as the pressing surface of the planar cam is raised; a means for energizing upward the stripper plate; and a locking member for restricting the raised end of the stripper plate. Thereby, in order to join together the end portions of the flat belt, the end portions of the belt can be subjected to cutting with the Thomson die.

### Effect of the Invention

According to the sheet cutter, when the die holding plate including the blade of the Thomson die (hereinafter referred to as Thomson blade) is lowered by the lever operation and the planar cam, the die holding plate presses downwardly the stripper plate during descent. Therefore, the sheet is held between the stripper plate and the mounting table, and above there, the Thomson blade protrudes from the slit of the stripper plate, thereby cutting the sheet. Thus, a single operation of rotating the lever ensures the smooth sequence of “pressing the sheet” and “cutting the sheet.”

Also, the operation force is increased by the lever, making it possible to apply a large force to depress the die holding plate. The planar cam is used at the point of action contacted with the die holding plate, making it possible to apply a larger cutting force.

Furthermore, when the lever is rotated to the original position, the Thomson blade is pulled up by the means for pulling up the die holding plate. At that occasion, the stripper plate is locked at a predetermined height position from the upper surface of the mounting table. Therefore, the sheet attached to the Thomson blade is obstructed and released by the stripper plate. Consequently, “the release of the sheet” can be easily and safely carried out by the operation of returning the lever to the original position.

The belt processing tool has a similar construction to that of the sheet cutter, and the Thomson die includes the blade having a predetermined shape for joining together the end portions of the belt. Therefore, the end portions of the belt can be cut into a complicated joint shape, such as the saw-tooth shape.

### BRIEF DESCRIPTION OF THE DRAWINGS

FIG. 1 is a perspective view showing a belt processing tool according to an embodiment of the present invention;

FIG. 2(a) is a schematic diagram showing an example of the joined state of the end portions of a belt processed by the belt processing tool according to the present invention; FIG. 2(b) is a cross-sectional view taken along the line I-I in FIG. 2(a);

FIG. 3 is a partially enlarged perspective view when the belt processing tool of FIG. 1 is viewed from a lower surface;

FIG. 4 is a schematic exploded perspective view of the belt processing tool of FIG. 1;

FIG. 5 is a partial cross-sectional side view of the belt processing tool of FIG. 1;

FIG. 6 is a partial enlarged perspective view of the belt processing tool of FIG. 1; and

FIG. 7 is a schematic process drawing showing the cutting process by the belt processing tool of FIG. 1.

### PREFERRED EMBODIMENTS FOR CARRYING OUT THE INVENTION

The belt processing tool according to an embodiment of the present invention is described below with reference to the drawings. The sheet cutter of the present invention is substantially the same as the belt processing tool, except that a cutting object thereof is a sheet.

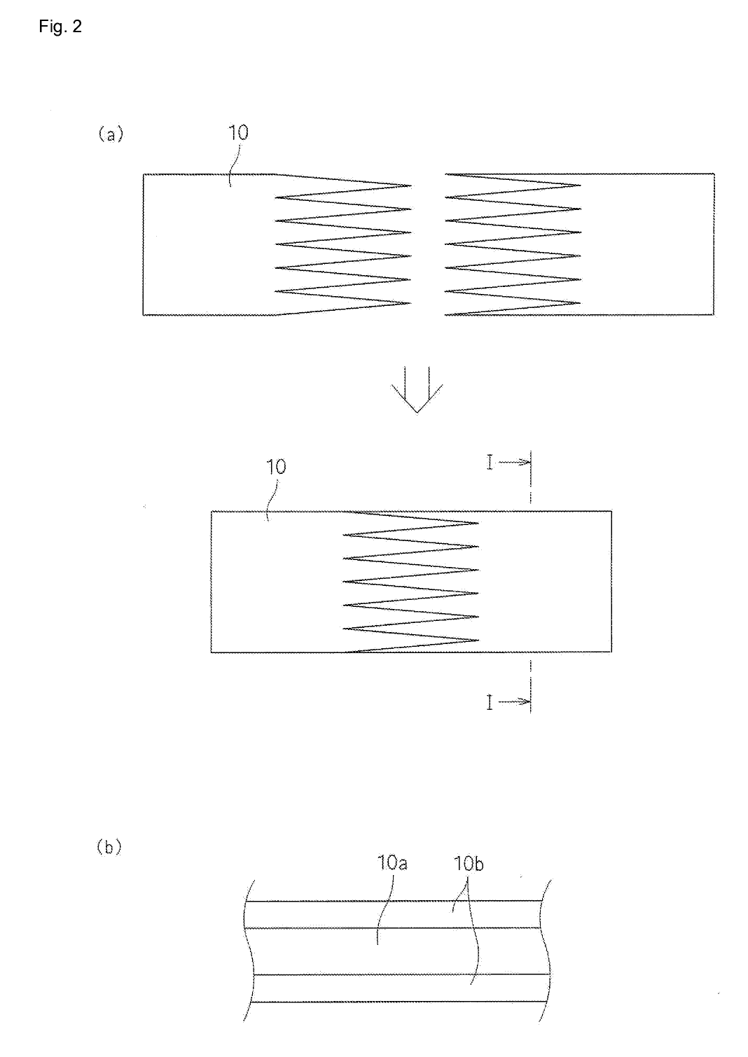

Firstly, the belt 10 cut by the belt processing tool of the present invention is described with reference to FIGS. 2(a) and 2(b).

The belt 10 shown in FIGS. 2(a) and 2(b) is an elongated sheet with a predetermined width, specifically a belt used for a belt conveyor, a conveyor device for a printing machine, or the like. The belt 10 is made up of a core material 10a, and an outer layer 10b laminated on both surfaces of the core material 10a, as shown in FIG. 2(b). The core material 10a is formed from a canvas, nonwoven fiber, or the like. The outer layer 10b is formed from natural rubber, various types of synthetic rubbers, or alternatively thermoplastic elastomer, or thermoplastic resin such as polyurethane or polyvinyl chloride. The belt cut by the belt processing tool of the present invention has a thickness of 0.5 to 2.5 mm, preferably 0.9 to 2.0 mm.

The technique called finger joint is employed to join together the end portions of the belt. According to this technique, as shown in FIG. 2(a), both end portions of the belt are formed into the saw-tooth shape. These two end portions are abutted against each other, and are engaged with each other so that the mountains of one end portion correspond to the valleys of the other end portion. The engaged portion is then subjected to bonding or welding. The width of the belt used in the belt processing tool of the present invention is 5 to 100 mm, preferably 10 to 50 mm. The number of the mountains formed in the width direction of the belt is 1 to 10, preferably 1 to 5. The height from the valley bottom to the mountain top is 20 to 200 mm, preferably 30 to 35 mm.

The saw-tooth shape of both end portions of the belt formed for the finger joint is not limited to the shape formed from a large number of sequential triangles as shown in FIG. 2(a). Optional shapes may be employed as long as both end portions of the belt can be joined together. For example, the shape formed from sequential trapezoids, rectangles, or waveforms may be employed instead of the triangles.

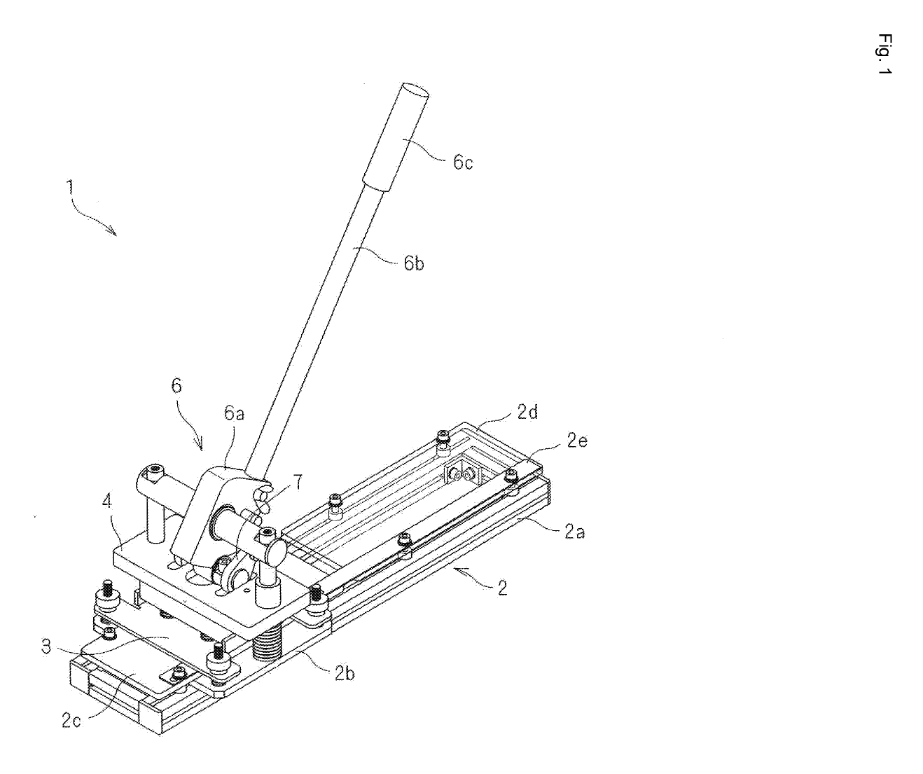

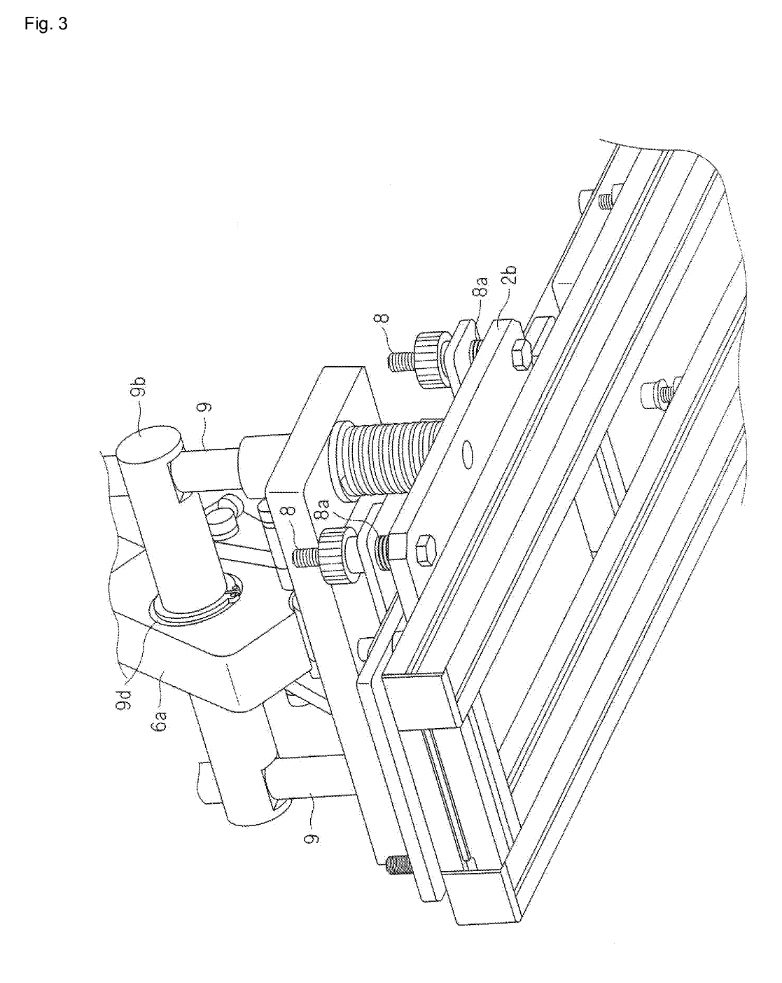

The belt processing tool 1 of the present invention shown in FIG. 1 includes a mounting table 2 for mounting the sheet (belt) thereon, a stripper plate 3 ascendably and descendably installed above the mounting table 2, a die holding plate 4 which is ascendably and descendably installed above the stripper plate 3, and descends while pressing the stripper plate 3 during descent, a Thomson die 5 fixedly held by the lower surface of the die holding plate 4, an operation member 6 for lowering the die holding plate 4, and a linking mechanism 7 (refer to FIG. 3) for raising the die holding plate 4 interlockingly with the operation member 6.

The mounting table 2 includes a rectangular frame body 2a that is long in the longitudinal direction of the belt; a base 2b (refer to FIG. 3) which is fixed onto the frame body 2a, and supports the operation member 6 and the like; a cutting seat 2c which is mounted on the upper surface of the base 2b to prevent the front end of the lowered Thomson blade 5b from hitting and being broken, and is formed of a synthetic resin such as rubber, high molecular weight polyethylene, or nylon; a support plate 2d extended to the rear of the frame body so as to be continuous with the cutting seat 2c; and a guide 2e which is installed along a side edge on the upper surface of the support plate 2d, and positions the side of the belt.

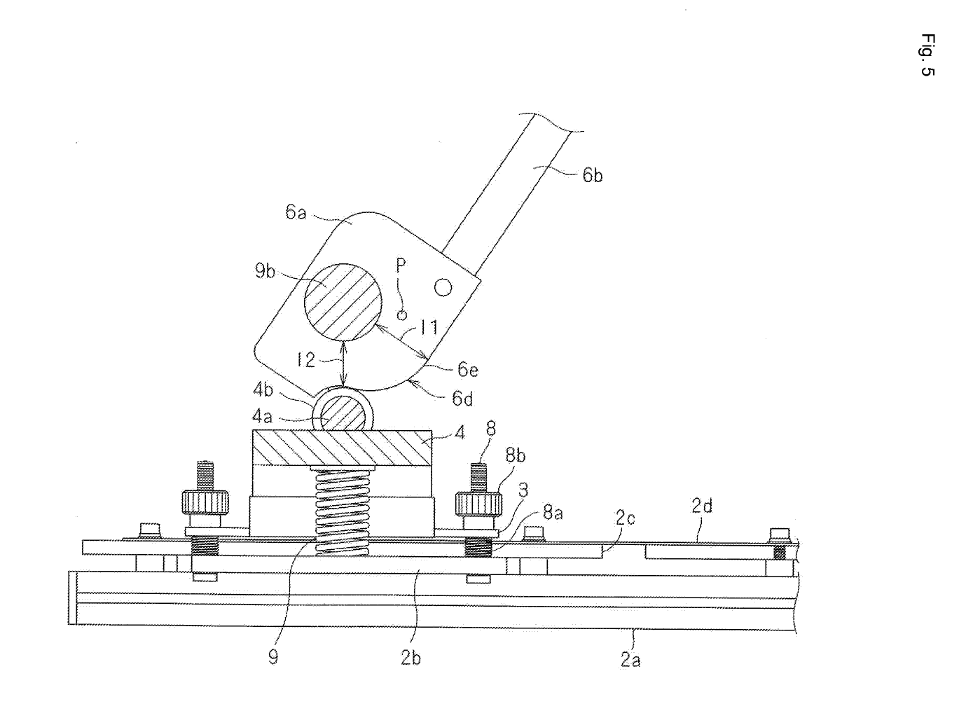

As shown in FIG. 3, bolt-shaped guide rods 8 for guiding the ascent and descent of the stripper plate 3 are secured to the base 2b. Through holes are formed in four corners of the base 2b, respectively. Large-diameter heads of the guide rods 8 are locked to the lower surface of the base 2b, and rod portions are projectedly extended upward from these through holes, respectively. Male threads are formed on the outer periphery of the upper end portions of the rod portions. Coil springs 8a (refer to FIG. 5) for upwardly energizing the stripper plate 3 are respectively attached to the periphery of the guide rods 8. These coil springs 8a are springs for ensuring a space to insert the belt between the stripper plate 3 and the cutting seat 2c after completing the cutting operation.

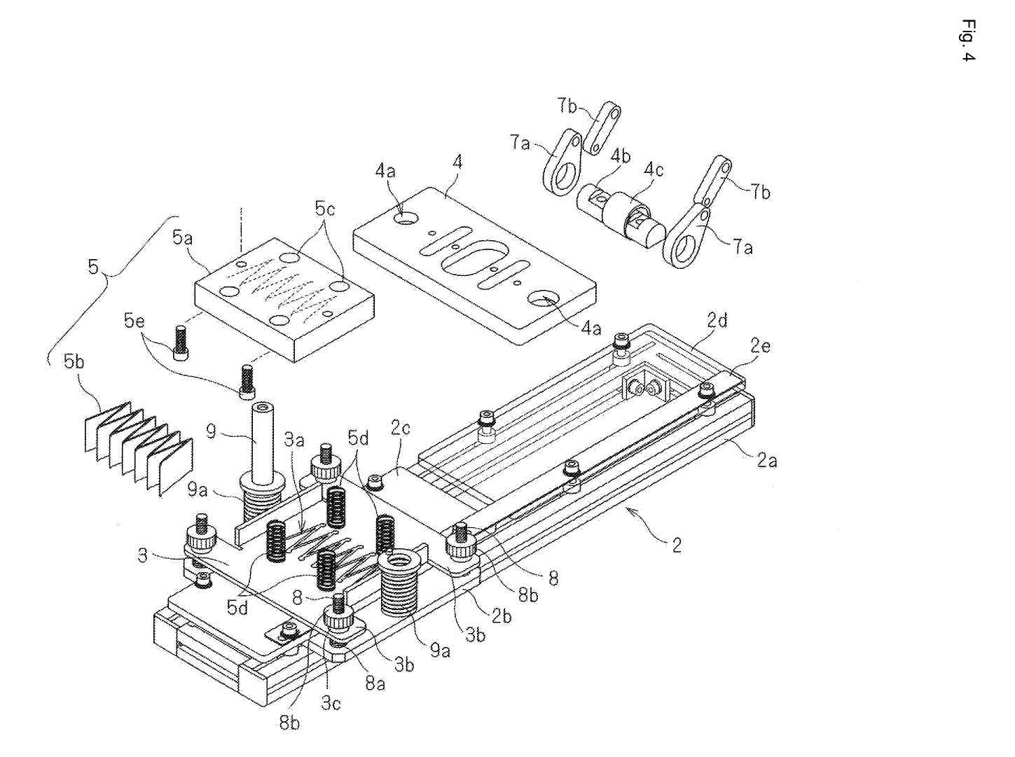

As shown in FIG. 4, the stripper plate 3 has a plate shape, and has, in the vicinity of the center thereof, a slit 3a having the same shape as a planar shape of the Thomson blade 5b. When the Thompson blade 5b is lowered, it is vertically slidably engaged with the slit 3a. Bracket portions 3b are formed at four corners of the stripper blade 3, and guide holes 3c axially slidably engaged with the guide rods 8 are formed in the bracket portions, respectively (refer to FIG. 5). The coil springs 8a are disposed between the base 2c and the stripper plate 3, and energize both in the direction to keep away from each other. A nut 8b is screwed onto each male thread at the upper end of the guide rod 8 projected from the stripper plate 3. Therefore, the raised end of the stripper plate 3 is restricted at a predetermined height with respect to the mounting table 2. The nut 8b can be rotated with fingers without a tool, thereby making it easier to replace the stripper plate 3. When replacing the Thomson die, the stripper plate is usually also replaced at the same time. The height of the stripper plate 3 can also be adjusted by adjusting the screwing position of the nut 8b.

Guide posts 9 extend upward from both right and left sides of the base 2b, respectively. The die holding plate 4 is ascendable and descendable while being guided by these guide posts 9 (refer to FIG. 3). A coil spring 9a, which is disposed between the base 2b and the die holding plate 4, and energizes both in the direction to keep away from each other, is installed along the periphery of each of the guide posts 9. Post holes 4a engaged with the guide posts 9 are formed in both sides of the die holding plate 4.

The Thomson die 5 includes a base 5a made of wood such as a plywood board, or a synthetic resin, and a saw-tooth shaped Thomson blade 5b embedded in the lower surface side of the base 5a. In the present embodiment, the Thomson blade 5b is formed into the saw-tooth shape for forming the finger joint (refer to FIG. 2(a)). The Thomson die 5 is fixed to the die holding plate 4 by fixing the base 5a to the lower surface of the die holding plate 4 with a fastener 5e, such as a bolt. A coil spring 5d, which energizes the stripper plate 3 and the die holding plate 4 in the direction to keep away from each other, is disposed therebetween. A back facing hole or through hole 5c for storing the upper portion of the coil spring 5d is formed in the base 5a. The through hole 5c can also be served as a hole for inserting the bolt for fixing the base 5a to the die holding plate 4. In the present embodiment, the lower end of the coil spring 5d is abutted against the upper surface of the stripper plate 3, and the upper end thereof is abutted against the lower surface of the die holding plate 4. Therefore, the base 5a and the stripper plate 3 can be brought near each other, thus saving space in the height direction.

As shown in FIG. 3, a support shaft 9b is fixedly passed through the upper end portions of the right and left guide posts 9 and 9. The operation member 6 includes a planar cam 6a rotatably engaged to the support shaft 9b through a bearing 9d, such as a bearing bush, collar, or the like; and a lever 6b (refer to FIG. 1) extended obliquely upward from the rear end of the planar cam 6a. A grip 6c is disposed at the free end of the lever 6b. As shown in FIG. 4, a roller shaft 4b is installed on the upper surface of the die holding plate 4. A cylindrical roller 4c is rotatably engaged with the periphery of the roller shaft 4b. The roller 4c is formed of metal or synthetic resin, and preferably has high strength and satisfactory sliding properties. As shown in FIG. 5, the roller 4c acts as a cam follower cooperating with the planar cam 6a. A cam surface 6d for gradually increasing the distance from the rotary shaft is formed on a lower peripheral surface of the planar cam 6a. The distance from the rotation center of the cam surface 6d is the shortest (12) at a portion abutted against the roller 4c in FIG. 5, and becomes longer (11) as it goes to the right in FIG. 5. Accordingly, when the lever 6b is rotated clockwise in FIG. 5, the roller 4c abutted against the cam surface 6d is gradually lowered, and the die holding plate 4 reaches the lowered end when a portion 6e having the longest distance from the rotation center is located immediately below. When the planar cam 6a is rotated to raise and lower the Thomson die, the roller 4c rolls along the cam surface 6d, thereby decreasing friction. Therefore, the cutting can be carried out by an easy operation.

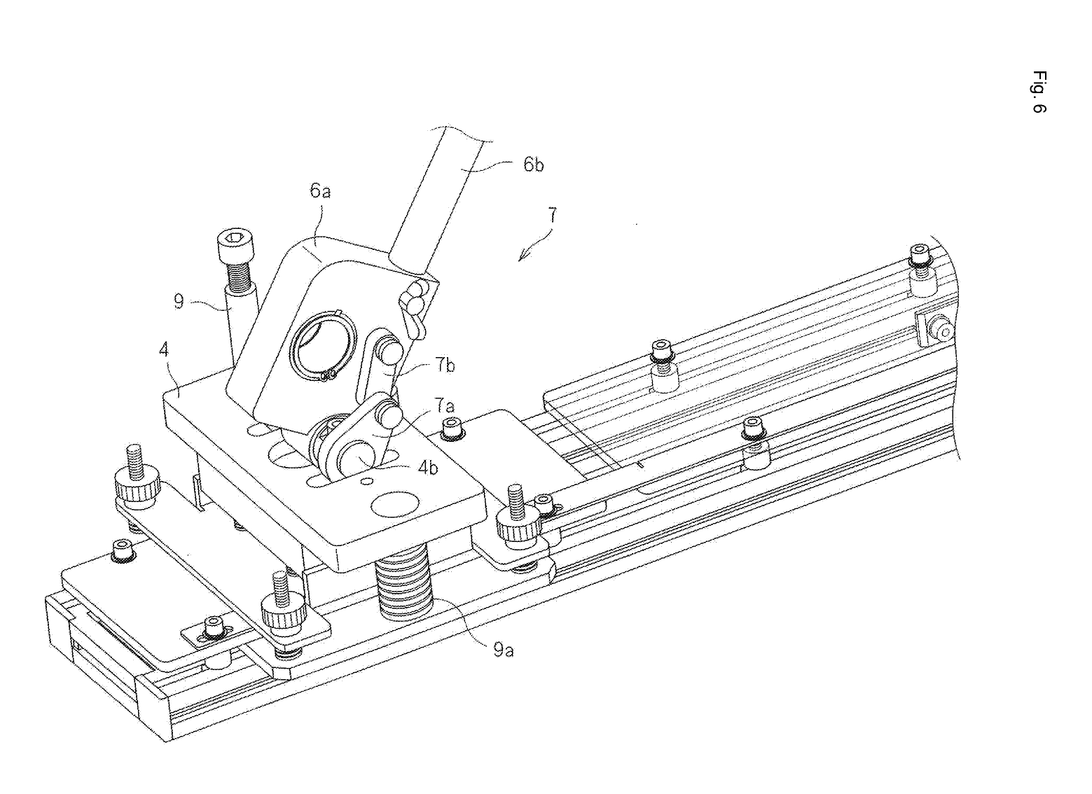

The linking mechanism 7 includes a pair of right and left first links 7a pivotally supported on both end portions of the roller shaft 4b, and a pair of right and left second links 7b rotatably connected to the other end portions of these first links 7a. The other end portions of these second links 7b are rotatably connected to the side surface of the planar cam 6a, as shown in FIG. 6. The connection position (point P in FIG. 5) is a portion located at a relatively upper side when the lever 6b is raised, and is located in the vicinity of the portion 6e being remote from the rotation center. That is, the linking mechanism 7 is bent at a position where the die holding plate 4 is most lowered (the surface portion 6e is located at the lowest point) by depressing the lever 6b, and extends linearly when the portion 6e being remote from the rotation center is located at the uppermost position by pulling up the lever 6b. Therefore, the linking mechanism 7 transmits no force during the depression of the lever 6b, and extends during the upward rotation thereof, and pulls up the die holding plate 4 by transmitting force from halfway. At that occasion, the distance between the rotation center and the point P is considerably smaller than the distance between the rotation center and the grip 6c, and therefore, the die holding plate 4 can be easily pulled up by leverage. It is also easy to release the cut sheet (belt) from the Thomson blade.

The spring constants of the coil springs 8a upwardly energizing the stripper plate 3, the coil spring 5d between the die holding plate 4 and the stripper plate 3, and the coil spring 9a for raising the die holding plate 4 with respect to the base 5a are increased in that order. It is adjusted so that when the die holding plate 4 is lowered, firstly, the coil spring 8a upwardly energizing the stripper plate 3 is almost crushed, and thereafter the base coil spring 5d is compressed.

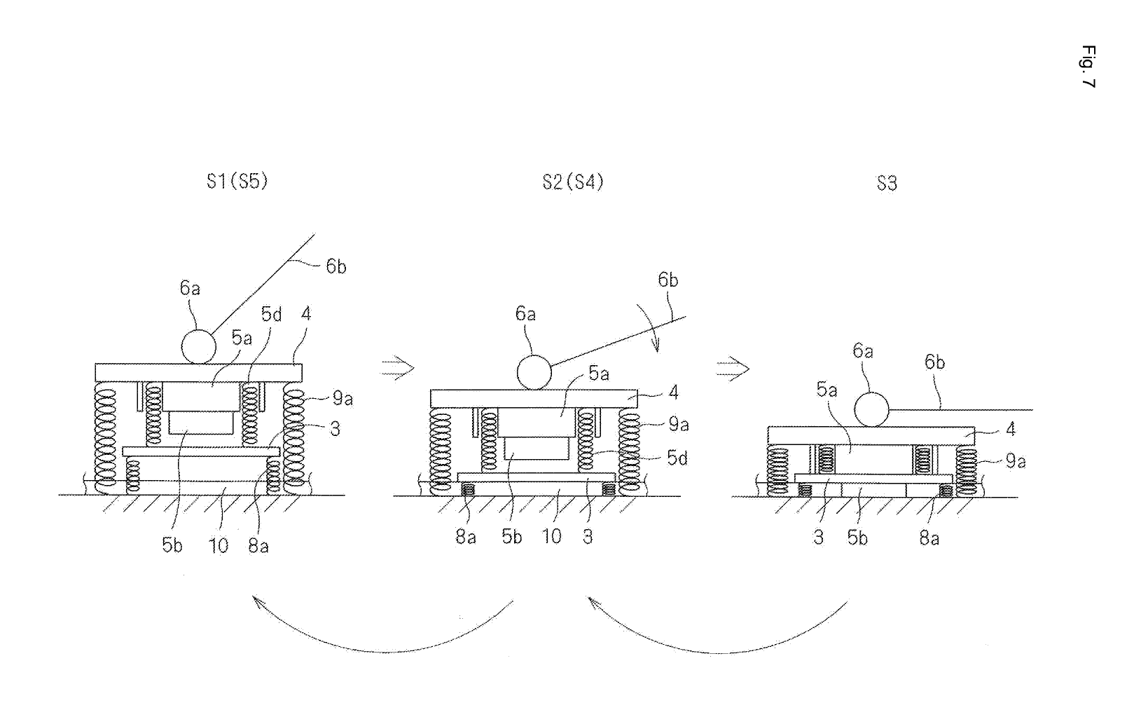

Next, the operation of cutting the belt by the belt processing tool of the present invention is described with reference to FIG. 7. The cutting operation includes the first step S1 of mounting the belt 10 of a predetermined width on the mounting table 2; the second step S2 in which the lever 6b is rotated to allow the planar cam 6a to press and lower the die holding plate 4, and the base 5a of the Thomson die 5 lowers the stripper plate 3 to press the belt 10; the third step S3 of cutting the belt 10 with the Thomson die 5 by further rotating the lever 6b; the fourth step S4 of raising the stripper plate 3 by rotating the lever 6b in the opposite direction to that during the cutting; and the fifth step S5 of pulling up the Thomson die 5 by further rotating the lever 6b.

In the second step S2, the die holding plate 4 for holding the Thomson blade 5b is lowered by the operation of depressing the lever 6b, and during descent, the die holding plate 4 presses downwardly the stripper plate 3 through the spring 5d. Therefore, the belt 10 is held between the stripper plate 3 and the mounting table 2, and above there, the Thomson blade 5b downwardly protrudes from the slit 3a (refer to FIG. 4) of the stripper plate 3 in the third step S3, thereby cutting the belt 10. That is, a single operation of rotating the lever 6b ensures the smooth sequence of “pressing the sheet” and “cutting the sheet.”

A large force to depress the die holding plate 4 can be applied by the lever operation (leverage), and the force can be transmitted to the roller 4c (refer to FIG. 5) of the die holding plate 4 by the planar cam 6a. Additionally, the rotary member 4c is arranged to roll on the planar cam 6a, thereby smoothly transmitting the rotational force of the lever 6b.

Further, the Thomson blade 5b is formed into the saw shape, and the slit 3a of the stripper plate 3 is formed into substantially the same shape as the saw shape of the Thomson blade 5b. Therefore, the upper surface in the vicinity of the cutting position of the belt 10 can be largely pressed by the stripper plate 3, thereby stabilizing the processing shape.

In the fourth step, when returning the lever 6b to the original position, the stripper plate 3 is locked at the predetermined height position from the upper surface of the mounting table 2. Therefore, the belt 10 attached to the Thomson blade 5b is obstructed and released by the stripper plate 3. Owing to the coil spring 5d for energizing the stripper plate 3 and the die holding plate 4 in the direction to keep away from each other, it is capable of preventing the stripper plate 3 from ascending, from the initial stage of raising the die holding plate 4, thereby aiding in releasing the bitten belt 10. Owing to the coil spring 9a for energizing the die holding plate 4 in the direction to be raised with respect to the mounting table 2, it is capable of aiding in raising the die holding plate 4 with respect to the mounting table 2.

In the fifth step, the linking mechanism 7 is raised by the rotation of the planar cam 6a during the operation of returning the lever 6b, and the Thomson blade 5b is forcedly raised through the die holding plate 4. Therefore, the belt 10 can be released more strongly by the force to rotate the lever, making it possible to immediately start the next operation, resulting in high operating efficiency.

Although the roller 4c is installed on the die holding plate 4, the roller 4c may be installed on the lever 6b, and the planar cam 6a may be installed on the upper surface of the die holding plate 4. Instead of the linking mechanism 7, a tension force transmission means having flexibility, such as a string or wire, may be used. Although in the foregoing embodiment, the belt is used as the cutting object, and the form of the Thomson blade 5b is the saw-tooth shaped cutting blade suitable for the finger joint, the shape of the Thomson blade 5b may be, besides the saw-tooth shape, a cutting die for a straight line shape, waveform, or the like.

The sheet cutter of the present invention has substantially the same construction as the foregoing belt processing tool, and is capable of using, as the Thomson die, a cutting die for cutting the sheet into the predetermined shape, such as a square or circle. In the case of using the cutting die, the cut sheet piece remains within the endless Thomson blade. Therefore, the cut sheet piece is preferably removed from the Thomson blade by a rectangular plate shaped or disk shaped stripper plate which is supported by the die holding plate 4 or the base 5a, and is energized downwardly by a spring. As the outer peripheral seat of the Thomson die, it is preferable to use the stripper plate ascendably and descendably provided on the mounting table, or the like.

1. A sheet cutter for cutting a sheet by a Thomson die, comprising:
a mounting table for mounting the sheet thereon;
a die holding plate being ascendable and descendable with respect to the mounting table, and having a lower surface to which the Thomson die is fixed;
a stripper plate being installed ascendably and descendably above the mounting table, and pressing an upper surface of the sheet during descent, and slidingly contacting with a blade of the Thomson die;
an operation member including a planar cam and a lever for rotating the planar cam, the planar cam being fixed to the mounting table and pivotally supported on a rotary shaft, and moving up and down by rotation, and having a surface for pressing downward the die holding plate;
a means for pulling upward the die holding plate as the pressing surface of the planar cam is raised;
a means for energizing upward the stripper plate; and
a locking member for restricting a raised end of the stripper plate.

2. A belt processing tool for cutting end portions of a flat belt by a Thomson die in order to join together the end portions of the belt, comprising:
a mounting table for mounting the end portions of the belt thereon;
a die holding plate being ascendable and descendable with respect to the mounting table, and having a lower surface to which the Thomson die is fixed;
a stripper plate being installed ascendably and descendably above the mounting table, and pressing an upper surface of the belt during descent, and having a slit through which a blade of the Thomson die passes;
an operation member including a planar cam and a lever for rotating the planar cam, the planar cam being fixed to the mounting table and pivotally supported on a rotary shaft, and moving up and down by rotation, and having a surface for pressing downward the die holding plate;
a means for pulling upward the die holding plate as the pressing surface of the planar cam is raised;
a means for energizing upward the stripper plate; and
a locking member for restricting a raised end of the stripper plate.

3. The belt processing tool according to claim 2, wherein the means for pulling upward the die holding plate comprises a linking mechanism disposed between the planar cam of the operation member and the die holding plate.

4. The belt processing tool according to claim 2, wherein a roller cooperating with the planar cam is rotatably installed on an upper surface of the die holding plate.

5. The belt processing tool according to claim 2, wherein the means for pulling upward the die holding plate comprises an elastic member which is disposed between the stripper plate and the die holding plate, and energizes both in a direction to keep away from each other.

6. The belt processing tool according to claim 2, wherein the means for pulling upward the die holding plate comprises an elastic member which is disposed between the die holding plate and the mounting table, and energizes the die holding plate in a direction to be raised with respect to the mounting table.

7. The belt processing tool according to claim 2, wherein the blade of the Thomson die is formed into a saw-tooth shape, and the slit of the stripper plate is formed into substantially the same shape as the saw-tooth shaped blade of the Thomson blade.
